(19) United States
(12) Patent Application Publication
(10) Pub. No.: US 2026/0311208 A1
(43) Pub. Date: Oct. 8, 2026

(54) CONTEXTUAL LONG-TERM SURVIVAL OPTIMIZATION FOR CONTENT MANAGEMENT SYSTEM CONTENT SELECTION

(71) Applicant: Microsoft Technology Licensing, LLC, Redmond, WA (US)

(72) Inventors: Ruonan Hao, San Mateo, CA (US); Alexander Ping Tsun, Cupertino, CA (US); Derek Koh, San Mateo, CA (US); Aman Grover, San Carlos, CA (US); Zhengming Xing, Cupertino, CA (US); Rohit Kumar Patra, Brooklyn, NY (US); Yeou Shya Chiou, San Jose, CA (US); Declan Paul Boyd, San Mateo, CA (US)

(21) Appl. No.: 19/468,606

(22) Filed: Feb. 3, 2026

Related U.S. Application Data
(63) Continuation of application No. 18/395,346, filed on Dec. 22, 2023, now abandoned.

(51) Int. Cl. G06Q 30/0207

(52) U.S. Cl. CPC G06Q 30/0236

(57) ABSTRACT

A method involves first receiving a set of data on rewards associated with previously chosen content variant choices, selected based on an initial content variant choice model. This initial model is informed by a prior set of data. A second, updated content variant choice model is then determined based on this first set of reward data. When a request for selecting a content variant choice is received, it comes with contextual features. The method involves estimating the expected rewards for a range of content variant choices, considering these contextual features. Subsequently, a specific content variant choice is chosen based on both the updated model and the anticipated rewards. Finally, the chosen content variant is displayed on a device, responding to the initial request.

### CROSS-REFERENCE TO RELATED APPLICATIONS

The present application is a continuation of U.S. patent application Ser. No. 18/395,346 filed Dec. 22, 2023, which is incorporated by reference herein.

### BACKGROUND

The content that a content management system selects to present to users can affect how deeply the users engage with the system. Consider an example where a user of a professional networking content management system uses a free account for job seeking. The provider of the service may want to present content to the user requesting the user upgrade her account to a fee-based subscription account that provides the user with more job seeking and professional networking features. The content presented can be important. For example, if the content presented to the user expresses a professional networking intent such as “Network smarter with Premium” rather than a job seeking intent such as “Get hired faster with Premium,” then the job seeking user may be less inclined to upgrade her account from free to premium. Techniques disclosed herein address these issues.

### BRIEF DESCRIPTION OF THE DRAWINGS

The following detailed description of certain embodiments of the invention may be understood by reference to the following figures:

FIG. 1 illustrates an example process for contextual long-term survival optimization for content management system content selection.

FIG. 2 illustrates an example system for contextual long-term survival optimization for content management system content selection.

FIG. 3 depicts example content variants for different user intents.

FIG. 4 illustrates joint training of a content variant choice model with a content variant choice model.

FIG. 5 illustrates an example of a programmable electronic device that processes and manipulates data to perform tasks and calculations disclosed herein for contextual long-term survival optimization for content management system content selection.

### DETAILED DESCRIPTION

Systems, methods, and non-transitory computer-readable media (generally, “techniques”) are disclosed for contextual long-term survival optimization for content management system content selection.

### GENERAL OVERVIEW

As mentioned, the content selected by a content management system for presentation to users is vitally important for user engagement. Unfortunately, predicting which content will be successful beforehand is difficult. Therefore, experimentation is necessary. Along with this need for experimentation, successful communication is also essential.

The techniques disclosed herein effectively balance the need for experimentation (exploration) with the need to achieve success in the content selected for presentation to users (exploitation). This is achieved by processing previous content choices and their corresponding results (rewards). During each processing stage, a new distribution model, such as a Beta distribution, is established. In this model, each potential content variant choice is referred to as an “choice” of the distribution model, whether it pertains to exploitation or experimentation. Following this processing, the newly established choice distribution model is then utilized to select the content that will be presented.

As an example of the problem addressed herein, consider content that offers users the opportunity to upgrade account types (e.g., from a free account to a paid, premium account). A content management service might offer various premium account types featuring different monthly costs, service credits, and functionalities designed for specific user intents, such as job seeking, professional networking, sales lead tracking, and recruiting. Given the numerous possible variations of such content (potentially in the hundreds or thousands), it becomes challenging for the service provider to predict which content variants, when presented to users, will most effectively encourage account upgrades. Even more complex is the task of determining which content variants will yield the greatest long-term revenue for the service provider across various account types. Hence, in presenting account upgrade content to users, there's a risk that service providers may miss out on potential subscription revenue. Selecting the appropriate content is crucial not only for the content management system, which aims to encourage users to upgrade their accounts, but also for the users, who could greatly benefit from the premium features of the system. If unsuitable content is presented, users might overlook it, remaining unaware of the advantages a premium subscription could offer them. There may be more relevant content that could be presented to the user for better results.

The techniques enable improved exploitation of known effective content variants and exploration of other content variants. Furthermore, these techniques are applicable beyond just professional networking content management systems. They are versatile and can be employed in any type of content management system where the selection of content variants is useful. This includes systems like news and media platforms, e-commerce websites, social media networks, educational portals, streaming services, and personalized marketing platforms. The content presented to users in these systems may take various forms, such as articles, videos, product listings, social media posts, educational courses, personalized advertisements, interactive media, etc.

The techniques described herein adopt a multi-armed bandit approach, where multiple content variant options (or “content variant choices”) are available for selection. Each content variant choice is associated with a known or expected “reward” based on previous engagements with that variant. These expected rewards are utilized to maximize the total reward for users while also exploring some content variant choices that may not have the highest expected rewards. Over time, this strategy creates a balance between exploration, which involves choosing content variant choices with potentially high expected rewards, and exploitation, which involves selecting those with the highest known rewards. This balance leads to an increase in both overall reward and knowledge about which choices yield the best results.

The techniques begin by collecting data from previous decisions, such as the content variants that were selected for presentation to users. For instance, this could involve analyzing thousands or even millions of decisions made over a previous period, like the day before or the past week. The outcomes of these decisions are then processed to develop a new model for future decision-making. In some embodiments, the techniques employ a probability distribution (e.g., beta distribution) to estimate the expected reward associated with each option (or ‘choice’). Additionally, sampling methods (e.g., Thompson Sampling) are used in some embodiments to ensure that decisions across policies are not made in a uniformly identical manner.

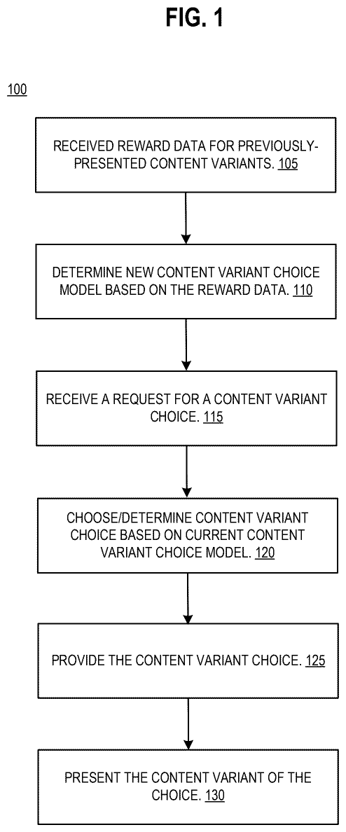

FIG. 1 illustrates a process for contextual long-term survival optimization for content management system content selection. In summary, the process 100 proceeds by determining 110 new content variant choice model based on reward data received 105 during a period of time. Once a request for a content variant choice is received 115, a determination 120 is made as to which content variant choice to choose for the request. This content variant choice is provided 125 in response to request. In some embodiments, the process 100 continues by presenting the content variant of the choice.

Consider, as an example, the processing of upgrade offer content to be presented to users. This content might appear when a user visits a webpage, such as one containing their personal social networking, professional networking, or news feed, or it could be sent in an email. The choice of content for presentation, as discussed elsewhere herein, can significantly influence the success of these presentations in encouraging users to upgrade from one type of account (e.g., a “free” account) to another (e.g., a “premium” or “pro” account). Process 100 may be employed both to experiment with different content variants and to exploit what is believed to be the most effective content variants for these presentations.

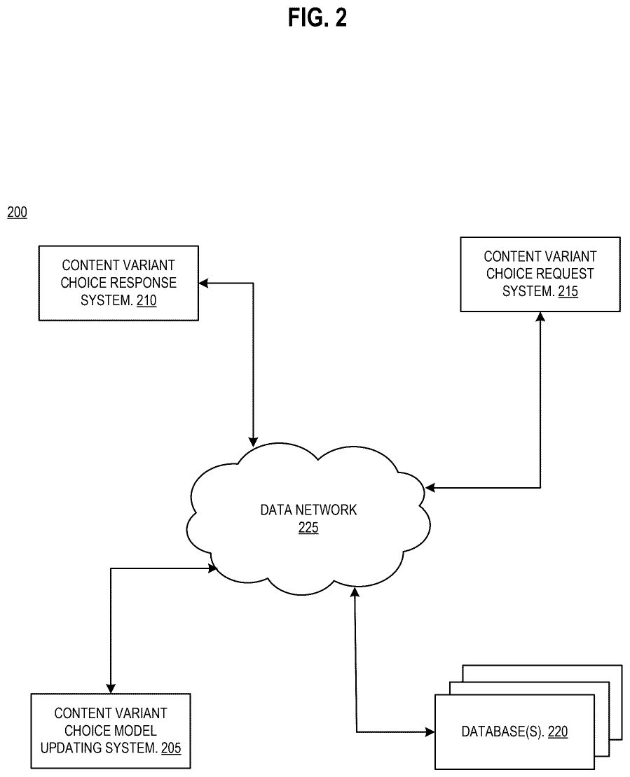

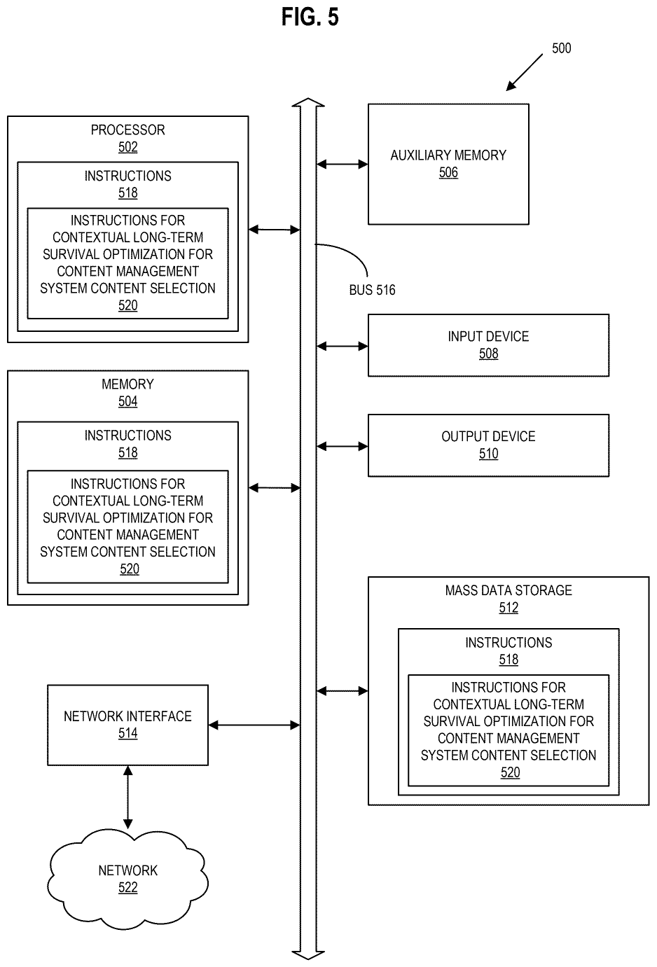

The system depicted in FIG. 2 or one or more of the programmable electronic devices in FIG. 5 may be used to implement process 100, process 200, and other embodiments herein.

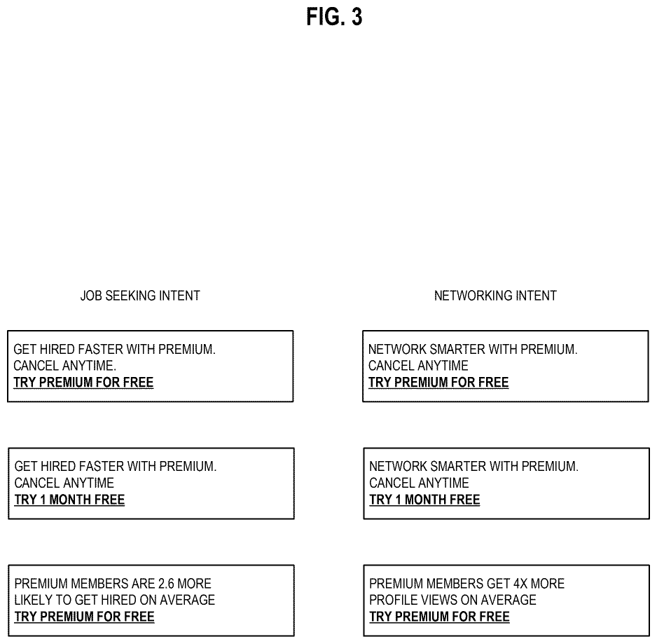

In many of the examples herein, the choices in the choice model are content variants (e.g., different text combinations for the user in question). For example, the choices may encompass a title and a subtitle for different user intents, yielding N*M total choices where N is the number of choices per customer intent and M is the total number of user intents. For example, FIG. 3 depicts a total of six choices, three choices per each of two user intents. Each choice has a title (e.g., “TRY PREMIUM FOR FREE”) and a subtitle (e.g., “NETWORK SMARTER WITH PREMIUM. CANCEL ANYTIME”).

Further, each choice may include an account type status of the user in question such as “eligible,” “re-eligible,” or “ineligible.” The status “eligible” may mean that the user is eligible for a free trial because they never signed up for a premium account. The status “re-eligible” may mean that the user is eligible for a free trial because while they have signed up for a premium account it was a long time ago that they did so (e.g., over 12 months ago). The status “ineligible” may mean that the user is not eligible for a free trial because they signed up for a premium account a short time ago (e.g., within the last 12 months).

Additionally, or alternatively, each choice may include a premium account type, or a combination of two or more premium account types, where there are different ways to present premium accounts. For example, for a given intent such as job seeking, the system can choose to show only one account type (e.g., only Premium Career Plan), two relevant account types (e.g., Premium Career and Premium Business) or present all account types available (e.g., All Premium account types).

In addition to, or as an alternative to, any of the foregoing possibilities, each choice may include a premium subscription pricing discount. For example, some possible discounts might be: (1) 50% off for 2 months, (2) 25% off for life, etc.

With the choices encompassing various content variant options for different user intents, each including text content, user eligibility status, premium subscription type, and discount type, offers benefits in content management and user engagement strategies. Each choice represents a unique combination of these elements, providing an array of choices for personalizing user experiences. The multi-armed bandit techniques, with the capability to continuously learn and adapt based on user responses (rewards), optimize the selection process over time for long-term user survival. It strikes a balance between exploring new combinations of content and exploiting known successful ones, thereby improving the efficiency of content delivery, and enhancing user satisfaction, conversion rates, and long-term survival. This approach is particularly advantageous in dynamic environments where user preferences and behaviors are constantly evolving, as it allows for real-time adjustments and optimizations in the content presented to users.

Providing diverse upgrade offer content variant choices significantly improves long-term user survival in subscription-based platforms. This strategy involves presenting users with a range of upgrade options, each tailored to different user intents. By doing so, the platform can more effectively resonate with individual users, offering them upgrade paths that are most relevant to their needs and interests. For instance, one variant choice might offer additional features that appeal to users seeking advanced functionalities, while another might focus on cost savings for budget-conscious users. This targeted approach ensures that upgrade offers are not one-size-fits-all but are instead carefully curated to match the diverse requirements of the user base. As users encounter upgrade offers that appear specifically designed for them, their likelihood of accepting these offers increases, leading to higher conversion rates. Moreover, this method allows the platform to gather valuable data on user preferences and response rates to different types of offers, enabling further refinement and personalization of future upgrade proposals. In the long term, this enhances user satisfaction and loyalty, as users perceive the platform as attuned to their specific needs and offering tangible value, thereby encouraging continued subscription and active engagement.

Returning to the beginning of process 100, reward data is received 105 for a previously executed action. The method of receiving this data can vary. In some embodiments, data might be obtained from another system, or it could be received through a different process or function within the same system. Alternatively, the data might be accessed in a shared memory space, such as a database or directory.

For example, as briefly referenced in FIG. 2, a content variant choice request system 215 may have previously requested certain choice actions to be taken (e.g., presenting content to users). Subsequently, reward data is received 105 indicating the outcomes of those previously executed content variant choice actions. This reward data, along with the associated content variant, may be stored in one or more databases 220 attached to the system. It could also be stored locally within the receiving systems 205, 210, or 215, or in any other suitable location.

Associating received 105 reward data with a particular previous request may involve using an attribution method for previously presented content variant choices. This approach is particularly useful in cases where it is unclear which content variant choice is associated with the received 105 reward data. For instance, if a user is presented with multiple content variants by system 215, determining which specific content variant should be attributed to any received 105 reward data can be challenging.

In some embodiments, attribution is accomplished by attributing a “click” by a user on a presented content variant to a reward. For example, if the user is shown the content variant in a graphical user interface at the user's device (e.g., personal computer or mobile smartphone) and the user interacts with the presented content variant by directing user input to it (e.g., a focus, a mouse click, or a touch gesture), then the “click” by the user would be attributed to that content variant.

In some embodiments, attribution is achieved by associating the only content variant presented during a specific period with a reward. For instance, if a single content variant is shown to a user, prompting them to upgrade their account, any subsequent account upgrade by the user would be attributed to that lone content variant. However, if multiple content variants are presented and it is unclear which one motivated the user to upgrade, the reward may be attributed to all the presented content variants. In such cases, a total reward could be divided among these variants, with each content variant receiving a weighted portion of the total reward. These weights would be higher for content variants shown closer to the time of the user's upgrade and lower for those presented earlier.

In some embodiments, attribution involves estimating the user's likelihood of long-term survival on the content management system and associating this estimated reward with a content variant presented to the user. This could be a variant the user clicked on or one linked to an account upgrade. Estimating the likelihood of long-term survival, especially in systems offering both free and premium accounts, may incorporate various analytical approaches. Firstly, user engagement metrics such as frequency of logins, session duration, and content interaction are insightful; high engagement often correlates with increased long-term retention. Secondly, analyzing the transition patterns from free to premium accounts is valuable. Users demonstrating interest in premium features, even without an immediate upgrade, might suggest a higher likelihood of prolonged use. Thirdly, feedback and user satisfaction surveys offer direct insights into user experience and potential longevity, with high satisfaction typically indicating a greater probability of continued use. Moreover, analyzing responses to marketing communications, like email open rates and upgrade offer click-throughs, can indicate levels of interest in sustained and enhanced usage. Machine learning models can further analyze these data points collectively, identifying patterns and more accurately predicting long-term user survival. In some cases, a specific user's likelihood of long-term survival is estimated based on historical data collected from that user. If sufficient historical data for a particular user is not available, estimates may be based on data from similar users.

Turning to FIG. 2, which is elaborated upon further below, systems 205, 210, and 215 are depicted as three separate entities to provide a clear example. However, it's important to note that two or more of these systems may be integrated into a single system, or any of these systems may comprise multiple subsystems. For instance, the content variant choice request system 215 could be implemented both as a system that requests actions to be taken on content variant choices and as a separate system or service that executes those requests.

For instance, the content variant choice request system 215 might request a content variant choice for a user in response to receiving a request from the user's device for a web page or other content provided by the content management system. As an example, this web page could be a personalized data feed, such as a social or professional networking feed, where the selected content variant will be displayed within the user's personalized feed. This content would appear among other items or posts that are tailored to the user's preferences.

A request for a content variant choice from the request system 215 may be received by the response system 210, which then proposes a specific content variant to be presented to the user. The request system 215 can facilitate the display of this content variant on the user's device. This could be achieved, for example, by sending a Hyper Text Transfer Protocol (HTTP) or Secure Hyper Text Transfer Protocol (HTTPS) response to the user's device, containing or referencing instructions (such as Hyper Text Markup Language (HTML) instructions) for rendering the content variant in a graphical user interface (like a web browser or mobile application window). Alternatively, the display of the content variant at the user's device may be managed by another system, not shown in FIG. 2.

Reward data may be received in one form and stored in another. In some embodiments, the received reward data might indicate an action taken or not taken by a user, as previously discussed. The stored reward data can then represent this action or inaction numerically or in any other appropriate form. For instance, the content variant choice model updating system 205, or any other system such as 210 or 215, may receive notification that a specific user “clicked on” a particular content variant, upgraded their account, or an estimate of the user's long-term survival following these actions. In such cases, the model updating system 205 may store a numerical reward associated with the specific content variant. Reward values could fall within ranges like [0, 1] or [−1, 1], or another suitable range, where higher numerical values correspond to greater rewards, and lower values indicate lesser rewards. It should be noted that a reward value can also represent a user's lack of action. For example, a reward for a content variant (possibly a lower or negative value) may indicate that although the content variant was presented to the user, they did not engage with it or upgrade their account within a certain period after its presentation.

In some embodiments, user inaction, which could indicate the lack of success of a presented content variant, may correspond to a low or negative reward. This inaction might be determined based on a timeout mechanism. For instance, if a content variant is presented to a user and they do not upgrade their account within a specified time period (such as one day or one week), this could be interpreted as the content variant being unsuccessful. Consequently, the timeout occurrence could be associated with a low or negative reward. Information regarding this timeout may be received 105 from another system or could be determined by the system itself, although this is not illustrated in FIG. 1.

In some embodiments, there may be multiple types or levels of rewards. Take, for example, the presentation of an upgrade content variant. The reward for such a presentation could vary based on the user's subsequent actions. A high reward might be given if the user upgrades their account following the presentation. A lesser reward could be attributed if the user clicks on the presented content variant but does not proceed to upgrade their account. An even smaller reward might be associated with the presentation if the user simply views the content variant without clicking on it or upgrading their account. As mentioned earlier, in some cases, user inaction, such as not clicking on the content variant or failing to upgrade their account after a certain timeout period, might also be considered when attributing rewards. Other factors that could influence the reward metrics include the user's account status type (e.g., eligible, re-eligible, or ineligible), the type of premium upgrade offered in the content variant, and any discounts associated with it. For instance, a premium “home” or “personal” account might yield a lower reward compared to a more expensive “business” or “professional” account. Similarly, a higher reward might be given for a user action on a content variant that does not include a discount, compared to one that does.

In some embodiments, receiving 105 a reward may involve obtaining click-through data. For instance, in the case of a content variant, if a user clicks on it, the reward data could be logged based on that click. To elaborate with the same content variant example, if the user not only clicks on the content variant but also upgrades their account, the reward may then be recorded 105 as being attributed to the user's interaction with the previously presented content variant.

In some embodiments, receiving 105 reward data may be delayed or may be based on log data or historical data. For example, data related to account upgrades, long-term survival activity, or clicks, and other types of rewards may be stored in one or more log files and the association of the reward data with content variant presentations may be based on processing that log data. In such a case, receiving 105 such reward data is delayed since it is received after the data is processed.

Process 100 is designed to collect reward data over a specific duration, such as until a certain time threshold is met. For instance, this data collection might occur over one hour, four hours, or a one-day period. In some embodiments, the reward data is gathered for a predetermined length of time, within specific real-world time windows (e.g., every 4 hours, or from 12 am to 12 μm and from 12 μm to 12 am), or until a set number of reward data-action pairs have been accumulated. For example, process 100 might be configured to collect reward data for at least a certain minimum duration (e.g., at least 12 hours) and continue, if necessary, until at least a predetermined number of reward data-action pairs are collected.

When enough reward data has been collected, a new content variant choice model is established 110 based on the reward data 105 received. This process 110 may involve correlating the rewards 105 with the specific content variants that were presented to users and for which the rewards were received. In some embodiments, the formulation of the new content variant choice model might also consider previously received reward data or earlier content variant choice policies, in addition to the most recently received reward data 105.

In some embodiments, an initial baseline content variant choice model is used, and the process of determining 110 a new content variant choice model is based on evaluating the performance of previous policies compared to alternatives. The data utilized to refine the content variant choice model may include a combination of factors such as the context in which content variants were presented, the details of the content variants themselves, and the rewards received for presenting each content variant.

In some embodiments, a combination of context C, content variant choice A, and reward (R) can be grouped into a triplet. The content variant choice A corresponds to a specific content variant that was presented to a user within the context C. The reward R refers to the reward received for presenting this content variant of choice A to the user. The context C might include various features such as information about the user, the content variant presented, or other aspects of the environment in which the content variant of choice A was shown to the user. These contextual features could encompass a range of elements, including but not limited to: the user's identity; their geographic location; the date or time when the content variant was presented; the type of device used for presentation (e.g., mobile or web); the text of the content variant (such as its title or subtitle); and features specific to choice A itself, like the user's account status at the time of presentation (e.g., eligible, re-eligible, or ineligible), the type of premium account promoted by the content variant, and any discounts offered or associated with the content variant presented. Additionally, any other relevant contextual features about the environment in which the content variant of choice A was presented to the user may also be included.

The features of context C can be represented using a variety of encoding techniques, each suitable for the specific type of feature being considered. These techniques include: one-hot encoding, useful for transforming categorical data into a binary vector with zeros except for a single one at the position representing the category; label encoding, which converts values in a categorical column into integer values; bag-of-words, applied to text data to create a set of word or n-gram frequencies; TF-IDF (Term Frequency-Inverse Document Frequency), which assesses a word's importance to a document in a collection by balancing word frequency against the number of documents containing the word; feature hashing, a fast and space-efficient method for vectorizing high-dimensional data; normalization, adjusting numeric feature scales to a [0,1] range; standardization, rescaling data to have a mean of 0 and standard deviation of 1; principal component analysis (PCA), used for dimensionality reduction by transforming data to a new coordinate system focusing on the greatest variances; word embeddings or other semantic embeddings, which map features into vectors in a continuous vector space to capture semantic relationships; graph embeddings, suitable for network-structured data to represent nodes in a low-dimensional space while preserving network topology and node neighborhood information; and other appropriate feature representation methods. Each of these techniques is selected based on its appropriateness for the particular feature at hand.

In some embodiments, one or more <context C, choice A, reward R>triplets are utilized to train the choice model. Specifically, the choice model is updated based on a set or collection S consisting of one or more such triplets. The new choice model is then formulated by considering both the current choice model and the set S. Essentially, the new choice model is derived by learning from either the previous or the current choice model in conjunction with the set S.

In some embodiments, the model updating system 205 can employ various methods to update the content variant choice model. For instance, the set S could comprise data acquired between time t and a later time t′ (where t′>t), or it might include all data collected up until time t′. Alternatively, set S may consist of only the data from the most recent collection period, or it could encompass all data that has been received to date.

In some embodiments, the choice model is incrementally updated by training (such as fine-tuning) on the data collected between time t and time t′, and then integrating these updates into the existing choice model.

In some embodiments, the choice model is updated from scratch by training on all available data, with or without utilizing the previous choice model.

In some embodiments, an initial choice model evenly distributes over the possible content variant choices. Alternatively, this distribution could be empirically determined, randomly seeded, based on historical or log data, or take another appropriate form. For instance, in certain embodiments, logged data containing triplets <context C, choice A, reward R> may be utilized to initialize the choice model.

In some embodiments, determining 110 the new choice model also involves learning a new expected rewards model associated with the choice model. This expected rewards model can range in complexity from a simple lookup table to an advanced neural network (such as a dense neural network). Additionally, in certain embodiments, both the expected rewards model and the choice model are saved each time they are created or updated. This practice enables the application of the expected rewards model and choice model to logged data for further analysis or refinement.

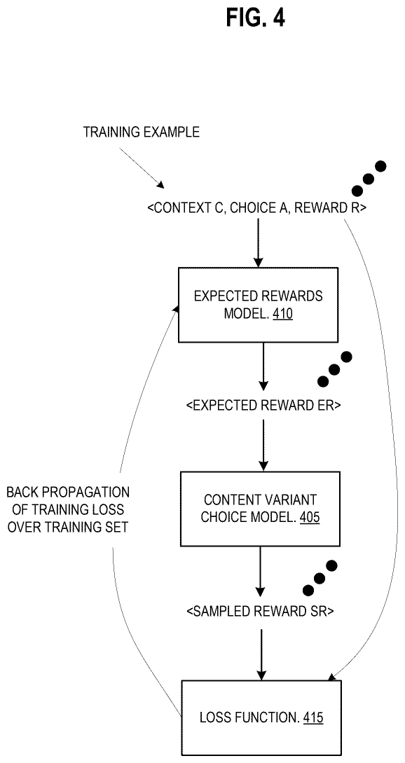

In some embodiments where the expected rewards model is a neural network, determining 110 the new choice model includes training (such as fine-tuning) the choice model using a set of <context C, choice A, reward R>triplets. For example, as illustrated in FIG. 4, an input training example triplet of <context C, choice A, reward R> is fed into the expected reward model 410, which then outputs an <expected reward ER>for the <context C, choice A>pair. This <expected reward ER> is subsequently input into the choice model 405, which samples (possibly randomly) a <sampled reward SR> from a distribution (e.g., a beta distribution) based on the <expected reward ER>for <choice A>. The choice model 405 may include such a distribution for each unique content variant choice. Both the <sampled reward SR> and the ground truth <reward R> are then input into a loss function 415—for instance, mean squared error or mean absolute error. The output from the loss function 415 influences the adjustment of the parameters of the expected rewards model 410 during the backpropagation process. The goal of the training is to minimize the loss across the set of training example triplets.

The integration of a neural network for predicting expected rewards, along with a choice model for probabilistic exploration and adaptation, enables the combined model (which incorporates both the expected rewards model and the choice model) to handle uncertainty more effectively. This approach ensures that the combined model not only learns about expected rewards but also gains insights into the variability and dynamics of those rewards over time. Training the neural network in conjunction with a choice model that includes distribution sampling is useful for accounting for uncertainty in several ways. Each content variant choice is associated with a specific distribution, allowing the combined model to develop a probabilistic understanding of expected rewards. Random sampling from these distributions as part of the choice model introduces an element of exploration. This exploration is useful as it enables the combined model to sometimes select actions that are less certain or less frequently chosen, which helps in avoiding local optima and fosters a more comprehensive understanding of the action space, particularly in areas of higher uncertainty. The neural network is trained to minimize the difference between the rewards sampled (which inherently include uncertainty due to the nature of distribution sampling) and the actual, ground truth rewards. Consequently, the neural network doesn't just learn from the straightforward expected rewards but also adapts to the variations introduced by the choice model. This training approach enhances the ability of the expected rewards model to generalize better and become more resilient to fluctuations and variations.

In some embodiments, determining 110 a new choice model may involve employing Thompson Sampling on the data under consideration, which could include the most recently collected data as well as data collected earlier. The probability distribution used in the Thompson Sampling may be based on various factors, such as counts of rewards, frequencies of success or failure of presented content variants, learnings from training, or any other suitable measure. Thompson Sampling can be conducted with a beta distribution or another appropriate distribution, such as epsilon-greedy. Utilizing Thompson Sampling to establish the new choice model offers advantages, particularly in achieving a desirable balance between selecting high-value content variant choices (exploitation) and ensuring a degree of diversity across all choices (exploration).

In some embodiments, the choice model generated through Thompson Sampling may be subject to variation or additional sampling. This is done to introduce a range or distribution in the actions suggested or taken based on the choice model. For instance, if Thompson Sampling yields a choice model that specifies which content variant choices should be presented to users, this model might include built-in sampling (or sampling introduced at a later stage) to allow for variability in its recommendations. Additionally, this variability can be incorporated at different stages of process 100. For example, it might be introduced when a specific content variant choice is being chosen or determined 120.

In some embodiments, multiple new choice policies will be determined 110 over time. Among these determinations, numerous requests for choices may be received 115. Receiving 115 a request for a choice typically involves acknowledging the need for a choice decision. Additionally, in some cases, the request for a choice might be accompanied by a set of contextual features that provide information about the request. For instance, a request for a choice 115 could include various details about the user who will be presented with the chosen content variant. This information might encompass, but is not limited to, the user's identity, their geographic location, the date or time when the request is received 115, the type of device for presenting the content variant (such as mobile or web), or any other relevant user features.

In some embodiments, the user features included in the request 115 encompass a predicted user intent, which reflects a machine learning-based prediction of the user's purpose for using the content management system. For instance, consider a content management system offering professional networking features across various verticals, including job seeking, professional networking, online learning courses for learning new skills, and recruiting skilled talent for job openings. In such a scenario, the user's intent could predominantly be one of the following: job seeking, professional networking, learning new skills, or recruiting. A machine learning-based system might predict the user's intent, and this prediction could then be included in the received request 115. This prediction can be based on profile and interaction data about the user (or similar users) collected by the system. For example, if a user has engaged in multiple online courses but hasn't applied for any jobs through the system, the prediction might lean towards a ‘learning new skills’ intent rather than ‘job seeking’. The specific categories of user intent can vary depending on the type of content management system. For a social networking system, for instance, user intent categories might include social connection, networking and professional growth, information and news, content creation and sharing, community engagement, influencer engagement, etc. In some embodiments, a user may have multiple predicted intents, and all these intents are included in the received request 115. These multiple intents can be ranked, weighted, or scored within the request to indicate the likelihood of each intent for the user.

In some embodiments, the user features included in the request 115 specify the graphical user interface “channel” of the content management system where the chosen content variant will be presented to the user. For example, a professional networking system may include any or all of the following channels: a “home feed” GUI where users can view updates, articles, and posts from their connections and followed companies or influencers; a “personal page” GUI displaying the user's professional information, experience, skills, and activity; a “messaging” GUI for private user communication, facilitating direct messages and networking; a “notifications” GUI alerting users to new activity related to their profile, posts, or network, such as new connections, job alerts, or content interactions; a “jobs section” GUI for job listing searches, personalized recommendations, and job applications; a “my network” GUI focused on managing and expanding a user's professional network, including connection requests and networking suggestions; a “search bar” GUI enabling searches for people, jobs, companies, posts, and more, with advanced options; a “groups” GUI for engaging in discussions and networking with professionals in similar industries or with shared interests; a “learning” GUI offering courses and learning paths for professional skill enhancement; “company pages” for businesses to showcase themselves, post updates, list job openings, and interact with followers; or any other suitable channel for a professional networking system.

Similar to the user's intent, the specific channels can vary depending on the type of content management system. For example, a social networking system may include any or all of the following channels: a “news feed” GUI where users can see posts, photos, videos, and updates from their friends, the pages they follow, and groups they are part of, a “profile page” GUI displaying the user's posts, photos, friends list, and personal information such as interests and work history; a “messenger” GUI for private and group conversations; a “notifications” GUI alerting users about new activity related to their account, including friend requests, comments, likes, and shares; a “groups” GUI providing spaces for users with common interests to share content, interact, and discuss specific topics; an “events” GUI for creating, managing, and discovering events, enabling users to organize gatherings and keep track of events their friends are interested in or attending; a “marketplace” GUI for buying, selling, and browsing items locally; a “pages” GUI offering public profiles designed for businesses, brands, celebrities, and organizations to connect with their audience and share content; a “watch” GUI for a video-on-demand service that allows watching and sharing videos, including original programming, user-uploaded content, and live broadcasts; a “search bar” GUI to find people, groups, pages, events, and posts; a “stories” GUI for sharing photos and videos that disappear after 24 hours or another predefined period; a “jobs” GUI where companies can post job openings and users can apply for jobs directly through the platform; or any other suitable channel for a social networking system.

The request received 115 may encompass a set of content variant choices for consideration as potential candidates. This set could include all content variant choices or a selected subset. In cases where a subset is chosen, it might be based on various properties of the content variant choices. As previously mentioned, these properties can comprise any or all of the following: the text of the content variant; whether the content variant is suited for “eligible” users, “re-eligible” users, or “ineligible” users, as previously discussed; the type of premium subscription being offered by the content variant; the user intent(s) that the content variant targets; the discount associated with the content variant; among others. Features of the received request 115 can be used to refine the selection of this subset. For instance, content variant choices that align with the user's intent might be preferentially selected.

In some embodiments, a subset of content variant choices that span multiple user intents are selected. The user intents may include user intents that are not indicated in the request received 115. By doing so, even content variant choices that are not for one of the user's intents may be explored or exploited leading, over time, to greater overall long-term survival rewards.

In some embodiments, a subset of content variant choices is selected to encompass multiple user intents, including those that may not be explicitly specified in the request received 115. This approach allows the system to explore or exploit content variant choices that might not align directly with the user's present intents. Such a strategy can enhance overall long-term survival rewards over time by expanding the range of content exploration and exploitation.

Requests may be received 115 from or on behalf of applications that are being used by users, from or on behalf of web pages or mobile applications that are being accessed by the user, from or on behalf of a content management system such as, for example, from or on behalf of a system that needs content to present to users, and the like. For example, requests for content variant choices may be received 115 from a system such as content variant choice request system 215 of FIG. 2 on behalf of a user using an application, in order to provide that user content.

After receiving 115 a request for a choice, which includes contextual features and a selected set of “target” choices, a choice is determined 120 for a response, and this choice is then provided 125 in response to the request. The process of determining 120 a choice involves using the contextual features associated with the request, along with the most recent expected rewards model and choice model. Specifically, an expected reward is calculated for each target choice in the request using the expected rewards model, which bases its determination on the request's contextual features and/or the features of the target choices. The current choice model dictates the current distribution (such as a beta distribution) for the expected reward of each choice. Notably, each target choice within the choice model has its own respective current distribution, which is periodically updated whenever a new choice model is established 110. Following Thompson sampling, a reward is randomly sampled from the current distribution of each choice to generate a set of sampled rewards for the target choices. The target choice with the greatest sampled reward is then selected as the choice to respond to the request. The greatest sampled reward may be the sampled reward with the highest numerical sampled reward in the set of sampled rewards for the target choices. For example, the choice model may encompass parameters of a continuous probability distribution for each target content variant choice. For example, the continuous probability distribution for a target choice may be represented as follows:

$$f ( x ; α , β ) = \frac{{{x}^{a - 1} ( 1 - β )}^{β - 1}}{B ( α , β )}$$

This continuous probability distribution is defined on the interval [0,1]. It is characterized by two parameters, alpha ‘α’ and beta ‘β’, which may be part of the choice model and updated based on previously received rewards each time the choice model is updated. These parameters control the shape of the distribution. Here, the input ‘x’ represents the expected reward for the target content variant choice. The parameter alpha ‘α’ is the first distribution shape parameter reflects the amount of evidence for positive outcome or success. A larger alpha parameter value relative to the beta parameter shifts the distribution towards 1. The parameter beta ‘β’ is the second shape parameter reflects the amount of evidence for a negative outcome or failure. A larger beta parameter value relative to the alpha parameter value shifts the distribution towards θ. The expression ‘B(α, β)’ is the Beta function, which serves as a normalization constant to ensure that the total probability integrates to 1.

To sample a value from such a distribution, a random number generator that can generate numbers according to the distribution may be used. For example, a standard library function such as the Python library function ‘numpy.random.beta (alpha, beta)’ may be used to generate a sample value from the current beta distribution for the choice in the choice model. The target choice with the highest sampled value may be selected as the content variant to present. This distribution and sampling approach provides an elegant solution because it naturally balances exploration of exploitation based on uncertainty in the expected rewards generated by the expected reward model. Target content variants with high uncertainty may be explored more, while target content variants with consistently high rewards may be exploited more.

As previously discussed, determining 120 choices based on the received 115 requests may involve introducing variability into the choice model. For instance, Thompson Sampling can be used to introduce this variability in the determinations 120 made using the choice model. Employing such sampling can be advantageous for ensuring variability in the choice model's decisions, particularly across multiple requests that share the same or similar contexts and/or the same or similar sets of target choices.

After the choice is determined 120, it may be provided 125 in response to the original request received 115. The response may be provided 125 by sending the request to the requester, by writing the content variant to be presented to data storage, or in any other appropriate manner. Responses may be provided 125 to the original requester to a system or device that will act on the requests.

In some embodiments, presenting 130 the chosen content variant occurs at the user's device for whom the content variant was selected. For instance, the text of the content variant can be displayed within a graphical user interface on the user's device.

In various embodiments, the choice model changes over time based on new data related to choices performed and rewards observed. This can be comparatively beneficial, because the needs of the choice model may change over time to optimize long-term survival of users that use the content management system. For example, the choice model can change over time as the predominate user intents of users using the content management system change from job seeking to learning such as, for example, as college students seek supplemental learning courses during the school term and seek jobs just before or after the school term ends.

FIG. 2 illustrates an example system designed for contextual long-term survival optimization in content management systems. The system shown in FIG. 2 represents just one embodiment that can be utilized for this purpose. However, alternative systems may also be employed. For instance, the system could comprise various scripts or programs that execute on any of the systems shown, as well as on systems not depicted in the figure. For example, the process of updating the choice model, as described herein, might be conducted by a model updating system 205, or it could be handled by another system 210 or 215, or even by another device or system not illustrated in FIG. 2.

As another example, requests for choices may be received from system 215, which could either generate such requests or act on behalf of other systems or devices (not depicted in FIG. 2) to send them. Additionally, while the choice response system 210 is shown as distinct from the model updating system 205, they could be combined into a single system in some embodiments. Furthermore, although systems 205, 210, and 215, along with storage 220, are illustrated as separate entities interconnected via network 225, any two or more of these components—or even all of them 205, 210, 215, and 220—could be integrated into the same system, server, or program.

In some embodiments, the process 100 of FIG. 1 may run on the system 200 of FIG. 2 and/or the hardware 500 of FIG. 5. For example, the described functions of process 100 may be performed by one or more systems 205, 210, or 215. Each system 205, 210, or 215 may run on a single computing device, multiple computing devices, in a distributed manner across a network, one or more virtual machines, which themselves run on one or more computing devices.

In some embodiments, systems 205, 210, and 215 are distinct sets of processes running on distinct sets of computing devices. In other embodiments, systems 205, 210, and 215 are intertwined or share processes or functions and/or run on the same computing devices.

In some embodiments, database(s) 220 are communicatively coupled to systems 205, 210, and 215 via a network 225 or other connection. Database(s) 220 may also be part of or integrated with one or more of systems 205, 210, and 215.

FIG. 5 illustrates an example of a programmable electronic device that processes and manipulates data to perform tasks and calculations disclosed herein for contextual long-term survival optimization for content management system content selection. Example programmable electronic device 500 includes electronic components encompassing hardware or hardware and software including processor 502, memory 504, auxiliary memory 506, input device 508, output device 510, mass data storage 512, and network interface 514, all connected to bus 516.

While only one of each type of component is depicted in FIG. 5 for the purpose of providing a clear example, multiple instances of any or all these electronic components may be present in device 500. For example, multiple processors may be connected to bus 516 in a particular implementation of device 500. Accordingly, unless the context clearly indicates otherwise, reference with respect to FIG. 5 to a component of device 500 in the singular such as, for example, processor 502, is not intended to exclude the plural where, in a particular instance of device 500, multiple instances of the electronic component are present. Further, some electronic components may not be present in a particular instance of device 500. For example, device 500 in a headless configuration such as, for example, when operating as a server racked in a data center, may not include, or be connected to, input device 508 or output device 510.

Processor 502 is an electronic component that processes (e.g., executes, interprets, or otherwise processes) instructions 518 including instructions 520 for contextual long-term survival optimization for content management system content selection. Processor 502 may perform arithmetic and logic operations dictated by instructions 518 and coordinate the activities of other electronic components of device 500 in accordance with instructions 518. Processor 502 may fetch, decode, and execute instructions 518 from memory 504. Processor 502 may include a cache used to store frequently accessed instructions 518 to speed up processing. Processor 502 may have multiple layers of cache (L1, L2, L3) with varying speeds and sizes. Processor 502 may be composed of multiple cores where each such core is a processor within processor 502. The cores may allow processor 502 to process multiple instructions 518 at once in a parallel processing manner. Processor 502 may support multi-threading where each core of processor 502 can handle multiple threads (multiple sequences of instructions) at once to further enhance parallel processing capabilities. Processor 502 may be made using silicon wafers according to a manufacturing process (e.g., 7 nm, 5 nm, or 3 nm). Processor 502 can be configured to understand and execute a set of commands referred to as an instruction set architecture (ISA) (e.g., x86, x86_64, or ARM).

Depending on the intended application, processor 502 can be any of the following types of central processing units (CPUs): a desktop processor for general computing, gaming, content creation, etc.; a server processor for data centers, enterprise-level applications, cloud services, etc.; a mobile processor for portable computing devices like laptops and tablets for enhanced battery life and thermal management; a workstation processor for intense computational tasks like 3D rendering and simulations; or any other suitable type of CPU.

While processor 502 can be a CPU, processor 502, depending on the intended application, can be any of the following types of processors: a graphics processing unit (GPU) capable of highly parallel computation allowing for processing of multiple calculations simultaneously and useful for rendering images and videos and for accelerating machine learning computation tasks; a digital signal processor (DSP) designed to process analog signals like audio and video signals into digital form and vice versa, commonly used in audio processing, telecommunications, and digital imaging; a tensor processing unit (TPU) or other specialized hardware for machine learning workloads, especially those involving tensors (multi-dimensional arrays); a field-programmable gate array (FPGA) or other reconfigurable integrated circuit that can be customized post-manufacturing for specific applications, such as cryptography, data analytics, and network processing; a neural processing unit (NPU) or other dedicated hardware designed to accelerate neural network and machine learning computations, commonly found in mobile devices and edge computing applications; an image signal processor (ISP) specialized in processing images and videos captured by cameras, adjusting parameters like exposure, white balance, and focus for enhanced image quality; an accelerated processing unit (APU) combing a CPU and a GPU on a single chip to enhance performance and efficiency, especially in consumer electronics like laptops and consoles; a vision processing unit (VPU) dedicated to accelerating machine vision tasks such as image recognition and video processing, typically used in drones, cameras, and autonomous vehicles; a microcontroller unit (MCU) or other integrated processor designed to control electronic devices, containing CPU, memory, and input/output peripherals; an embedded processor for integration into other electronic devices such as washing machines, cars, industrial machines, etc.; a system on a chip (SoC) such as those commonly used in smartphones encompassing a CPU integrated with other components like a graphics processing unit (GPU) and memory on a single chip; or any other suitable type of processor.

Memory 504 is an electronic component that stores data and instructions 518 that processor 502 processes. Memory 504 provides the space for the operating system, applications, and data in current use to be quickly reached by processor 502. For example, memory 504 may be a random-access memory (RAM) that allows data items to be read or written in substantially the same amount of time irrespective of the physical location of the data items inside memory 504.

In some instances, memory 504 is a volatile or non-volatile memory. Data stored in a volatile memory is lost when the power is turned off. Data in non-volatile memory remains intact even when the system is turned off. For example, memory 504 can be Dynamic RAM (DRAM). DRAM such as Single Data Rate RAM (SDRAM) or Double Data Rate RAM (DDRAM) is volatile memory that stores each bit of data in a separate capacitor within an integrated circuit. The capacitors of DRAM leak charge and need to be periodically refreshed to avoid information loss. Memory 504 can be Static RAM (SRAM). SRAM is volatile memory that is typically faster but more expensive than DRAM. SRAM uses multiple transistors for each memory cell but does not need to be periodically refreshed. Additionally, or alternatively, SRAM may be used for cache memory in processor 502.

Device 500 has auxiliary memory 506 other than memory 504. Examples of auxiliary memory 506 include cache memory, register memory, read-only memory (ROM), secondary storage, virtual memory, memory controller, and graphics memory. Device 500 may have multiple auxiliary memories including different types of auxiliary memories. Cache memory is found inside or very close to processor 502 and is typically faster but smaller than memory 504. Cache memory may be used to hold frequently accessed instructions 518 (encompassing any associated data) to speed up processing. Cache memory may be hierarchical ranging from Level 1 cache memory which is the smallest but fastest cache memory and is typically inside processor 502 to Level 2 and Level 3 cache memory which are progressively larger and slower cache memories that can be inside or outside processor 502. Register memory is a small but very fast storage location within processor 502 designed to hold data temporarily for ongoing operations. ROM is a non-volatile memory device that can only be read, not written to. For example, ROM can be a Programmable ROM (PROM), Erasable PROM (EPROM), or electrically erasable PROM (EEPROM). ROM may store basic input/output system (BIOS) instructions which help device 500 boot up. Secondary storage is a non-volatile memory. For example, a secondary storage can be a hard disk drive (HDD) or other magnetic disk drive device; a solid-state drive (SSD) or other NAND-based flash memory device; an optical drive like a CD-ROM drive, a DVD drive, or a Blu-ray drive; or flash memory device such as a USB drive, an SD card, or other flash storage device. Virtual memory is a portion of mass data storage 512 that the operating system uses as if it were memory 504. When memory 504 gets filled, less frequently accessed data and instructions 518 can be “swapped” out to the virtual memory. The virtual memory may be slower than memory 504, but it provides the illusion of having a larger memory 504. A memory controller manages the flow of data and instructions 518 to and from memory 504. The memory controller can be located either on the motherboard of device 500 or within processor 502. Graphics memory is used by a graphics processing unit (GPU) and is specially designed to handle the rendering of images, videos, graphics, or performing machine learning calculations. Examples of graphics memory include graphics double data rate (GDDR) such as GDDR5 and GDDR6.

Input device 508 is an electronic component that allows users to feed data and control signals into device 500. Input device 508 translates a user's action or the data from the external world into a form that device 500 can process. Examples of input device 508 include a keyboard, a pointing device (e.g., a mouse), a touchpad, a touchscreen, a microphone, a scanner, a webcam, a joystick/game controller, a graphics tablet, a digital camera, a barcode reader, a biometric device, a sensor, and a MIDI instrument.

Output device 510 is an electronic component that conveys information from device 500 to the user or to another device. The information can be in the form of text, graphics, audio, video, or other media representation. Examples of an output device 510 include a monitor or display device, a printer device, a speaker device, a headphone device, a projector device, a plotter device, a braille display device, a haptic device, a LED or LCD panel device, a sound card, and a graphics or video card.

Mass data storage 512 is an electronic component used to store data and instructions 518. Mass data storage 512 may be non-volatile memory. Examples of mass data storage 512 include a hard disk drive (HDD), a solid-state drive (SDD), an optical drive, a flash memory device, a magnetic tape drive, a floppy disk, an external drive, or a RAID array device. Mass data storage 512 could additionally or alternatively be connected to device 500 via network 522. For example, mass data storage 512 could encompass a network attached storage (NAS) device, a storage area network (SAN) device, a cloud storage device, or a centralized network filesystem device.

Network interface 514 (sometimes referred to as a network interface card, NIC, network adapter, or network interface controller) is an electronic component that connects device 500 to network 522. Network interface 514 functions to facilitate communication between device 500 and network 522. Examples of a network interface 514 include an ethernet adaptor, a wireless network adaptor, a fiber optic adapter, a token ring adaptor, a USB network adaptor, a Bluetooth adaptor, a modem, a cellular modem or adapter, a powerline adaptor, a coaxial network adaptor, an infrared (IR) adapter, an ISDN adaptor, a VPN adaptor, and a TAP/TUN adaptor.

Bus 516 is an electronic component that transfers data between other electronic components of or connected to device 500. Bus 516 serves as a shared highway of communication for data and instructions (e.g., instructions 518), providing a pathway for the exchange of information between components within device 500 or between device 500 and another device. Bus 516 connects the different parts of device 500 to each other. For example, bus 516 may encompass one or more of: a system bus, a front-side bus, a data bus, an address bus, a control bus, an expansion bus, a universal serial bus (USB), a I/O bus, a memory bus, an internal bus, an external bus, and a network bus.

Instructions 518 are computer-processable instructions that can take different forms. Instructions 518 can be in a low-level form such as binary instructions, assembly language, or machine code according to an instruction set (e.g., x86, ARM, MIPS) that processor 502 is designed to process. Instructions 518 can include individual operations that processor 502 is designed to perform such as arithmetic operations (e.g., add, subtract, multiply, divide, etc.); logical operations (e.g., AND, OR, NOT, XOR, etc.); data transfer operations including moving data from one location to another such as from memory 504 into a register of processor 502 or from a register to memory 504; control instructions such as jumps, branches, calls, and returns; comparison operations; and specialization operations such as handling interrupts, floating-point arithmetic, and vector and matrix operations. Instructions 518 can be in a higher-level form such as programming language instructions in a high-level programming language such as Python, Java, C++, etc. Instructions 518 can be in an intermediate level form in between a higher-level form and a low-level form such as bytecode or an abstract syntax tree (AST).

Instructions 518 for processing by processor 502 can be in different forms at the same or different times. For example, when stored in mass data storage 512 or memory 504, instructions 518 may be stored in a higher-level form such as Python, Java, or other high-level programing language instructions, in an intermediate-level form such as Python or Java bytecode that is compiled from the programming language instructions, or in a low-level form such as binary code or machine code. When stored in processor 502, instructions 518 may be stored in a low-level form such as binary instructions, assembly language, or machine code according to an instruction set architecture (ISA). However, instructions 518 may be stored in processor 502 in an intermediate level form or even a high-level form where processor 502 can process instructions in such form.

Instructions 518 may be processed by one or more processors of device 500 using different processing models including any or all of the following processing models depending on the intended application: sequential execution where instructions are processed one after another in a sequential manner; pipelining where pipelines are used to process multiple instruction phases concurrently; multiprocessing where different processors different instructions concurrently, sharing the workload; thread-level parallelism where multiple threads run in parallel across different processors; simultaneous multithreading or hyperthreading where a single processor processes multiple threads simultaneously, making it appear as multiple logical processors; multiple instruction issue where multiple instruction pipelines allow for the processing of several instructions during a single clock cycle; parallel data operations where a single instruction is used to perform operations on multiple data elements concurrently; clustered or distributed computing where multiple processors in a network (e.g., in the cloud) collaboratively process the instructions, distributing the workload across the network; graphics processing unit (GPU) acceleration where GPUs with their many processors allow the processing of numerous threads in parallel, suitable for tasks like graphics rendering and machine learning; asynchronous execution where processing of instructions is driven by events or interrupts, allowing the one or more processors to handle tasks asynchronously; concurrent instruction phases where multiple instruction phases (e.g., fetch, decode, execute) of different instructions are handled concurrently; parallel task processing where different processors handle different tasks or different parts of data, allowing for concurrent processing and execution; or any other suitable processing model.

Network 522 is a collection of interconnected computers, servers, and other programmable electronic devices that allow for the sharing of resources and information. Network 522 can range in size from just two connected devices to a global network (e.g., the internet) with many interconnected devices. Individual devices on network 522 are sometimes referred to as “network nodes.” Network nodes communicate with each other through mediums or channels sometimes referred to as “network communication links.” The network communication links can be wired (e.g., twisted-pair cables, coaxial cables, or fiber-optic cables) or wireless (e.g., Wi-Fi, radio waves, or satellite links). Network 522 may encompass network devices such as routers, switches, hubs, modems, and access points. Network nodes may follow a set of rules sometimes referred to “network protocols” that define how the network nodes communicate with each other. Example network protocols include data link layer protocols such as Ethernet and Wi-Fi, network layer protocols such as IP (Internet Protocol), transport layer protocols such as TCP (Transmission Control Protocol), application layer protocols such as HTTP (Hypertext transfer Protocol) and HTTPS (HTTP Secure), and routing protocols such as OSPF (Open Shortest Path First) and BGP (Border Gateway Protocol). Network 1122 may have a particular physical or logical layout or arrangement sometimes referred to as a “network topology.” Example network topologies include bus, star, ring, and mesh. Network 522 can be different of different sizes and scopes. For example, network 522 can encompass some or all of the following categories of networks: a personal area network (PAN) that covers a small area (a few meters), like a connection between a computer and a peripheral device via Bluetooth; a local area network (LAN) that covers a limited area, such as a home, office, or campus; a metropolitan area network (MAN) that covers a larger geographical area, like a city or a large campus; a wide area network (WAN) that spans large distances, often covering regions, countries, or even globally (e.g., the internet); a virtual private network (VPN) that provides a secure, encrypted network that allows remote devices to connect to a LAN over a WAN; an enterprise private network (EPN) build for an enterprise, connecting multiple branches or locations of a company; or a storage area network (SAN) that provides specialized, high-speed block-level network access to storage using high-speed network links like Fibre Channel.

As used herein and in the appended claims, the term “computer-readable media” refers to one or more mediums or devices that can store or transmit information in a format that a computer system can access. Computer-readable media encompasses both storage media and transmission media. Storage media includes volatile and non-volatile memory devices such as RAM devices, ROM devices, secondary storage devices, register memory devices, memory controller devices, graphics memory devices, and the like.

As used herein and in the appended claims, the term “non-transitory computer-readable media” as used herein encompasses computer-readable media as just defined but excludes transitory, propagating signals. Data stored on non-transitory computer-readable media isn't just momentarily present and fleeting but has some degree of persistence. For example, instructions stored in a hard drive, a SSD, an optical disk, a flash drive, or other storage media are stored on non-transitory computer-readable media. Conversely, data carried by a transient electrical or electromagnetic signal or wave is not stored in non-transitory computer-readable media when so carried.

As used herein and in the appended claims, unless otherwise clear in context, the terms “comprising,” “having,” “containing,” “including,” “encompassing,” “in response to,” “based on,” and the like are intended to be open-ended in that an element or elements following such a term is not meant to be an exhaustive listing of elements or meant to be limited to only the listed element or elements.

Unless otherwise clear in context, relational terms such as “first” and “second” are used herein and in the appended claims to differentiate one thing from another without limiting those things to a particular order or relationship. For example, unless otherwise clear in context, a “first device” could be termed a “second device.” The first and second devices are both devices, but not the same device.

Unless otherwise clear in context, the indefinite articles “a” and “an” are used herein and in the appended claims to mean “one or more” or “at least one.” For example, unless otherwise clear in context, “in an embodiment” means in at least one embodiment, but not necessarily more than one embodiment. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C. Unless otherwise explicitly stated, the terms “set”, and “collection” should generally be interpreted to include one or more described items throughout this application. Accordingly, phrases such as “a set of devices configured to” or “a collection of devices configured to” are intended to include one or more recited devices. Such one or more recited devices can also be collectively configured to carry out the stated recitations. For example, “a set of servers configured to carry out recitations A, B and C” can include a first server configured to carry out recitation A working in conjunction with a second server configured to carry out recitations B and C.

As used herein, unless otherwise clear in context, the term “or” is open-ended and encompasses all possible combinations, except where infeasible. For example, if it is stated that a component may include A or B, then, unless infeasible or otherwise clear in context, the component may include at least A, or at least B, or at least A and B. As a second example, if it is stated that a component may include A, B, or C then, unless infeasible or otherwise clear in context, the component may include at least A, or at least B, or at least C, or at least A and B, or at least A and C, or at least B and C, or at least A and B and C.

Unless the context clearly indicates otherwise, conjunctive language in this description and in the appended claims such as the phrase “at least one of X, Y, and Z,” is to be understood to convey that an item, term, etc. can be either X, Y, or Z, or a combination thereof. Thus, such conjunctive language does not require that at least one of X, at least one of Y, and at least one of Z to each be present.

Unless the context clearly indicates otherwise, the relational term “based on” is used in this description and in the appended claims in an open-ended fashion to describe a logical (e.g., a condition precedent) or causal connection or association between two stated things where one of the things is the basis for or informs the other without requiring or foreclosing additional unstated things that affect the logical or casual connection or association between the two stated things.

Unless the context clearly indicates otherwise, the relational term “in response to” is used in this description and in the appended claims in an open-ended fashion to describe a stated action or behavior that is done as a reaction or reply to a stated stimulus without requiring or foreclosing additional unstated stimuli that affect the relationship between the stated action or behavior and the stated stimulus.

The techniques described herein may be implemented with privacy safeguards to protect user privacy. Furthermore, the techniques described herein may be implemented with user privacy safeguards to prevent unauthorized access to personal data and confidential data. The training of the AI models described herein is executed to benefit all users fairly, without causing or amplifying unfair bias.

According to some embodiments, the techniques for the models described herein do not make inferences or predictions about individuals unless requested to do so through an input. According to some embodiments, the models described herein do not learn from and are not trained on user data without user authorization. In instances where user data is permitted and authorized for use in AI features and tools, it is done in compliance with a user's visibility settings, privacy choices, user agreement and descriptions, and the applicable law. According to the techniques described herein, users may have full control over the visibility of their content and who sees their content, as is controlled via the visibility settings. According to the techniques described herein, users may have full control over the level of their personal data that is shared and distributed between different AI platforms that provide different functionalities. According to the techniques described herein, users may have full control over the level of access to their personal data that is shared with other parties. According to the techniques described herein, personal data provided by users may be processed to determine prompts when using a generative AI feature at the request of the user, but not to train generative AI models. In some embodiments, users may provide feedback while using the techniques described herein, which may be used to improve or modify the platform and products. In some embodiments, any personal data associated with a user, such as personal information provided by the user to the platform, may be deleted from storage upon user request. In some embodiments, personal information associated with a user may be permanently deleted from storage when a user deletes their account from the platform.

According to the techniques described herein, personal data may be removed from any training dataset that is used to train AI models. The techniques described herein may utilize tools for anonymizing member and customer data. For example, user's personal data may be redacted and minimized in training datasets for training AI models through delexicalisation tools and other privacy enhancing tools for safeguarding user data. The techniques described herein may minimize use of any personal data in training AI models, including removing and replacing personal data. According to the techniques described herein, notices may be communicated to users to inform how their data is being used and users are provided controls to opt-out from their data being used for training AI models.

According to some embodiments, tools are used with the techniques described herein to identify and mitigate risks associated with AI in all products and AI systems. In some embodiments, notices may be provided to users when AI tools are being used to provide features.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method, comprising:
generating a first output using a first machine learning-based model based on context data and choice data of a first training data item;
generating a second output using a second machine learning-based model, wherein the second output comprises an output sampled from a distribution generated based on the first output and reward data of the first training data item;
generating a loss function output using a loss function based on the second output and the reward data of the first training data item; and
updating the first machine learning-based model based on the loss function output.

2. The method of claim 1, wherein the first machine learning-based model is an expected rewards model, and the method further comprises, by the expected rewards model, generating an expected reward output as the first output.

3. The method of claim 2, wherein the expected reward output comprises an expected user interaction with the choice data based on the context data.

4. The method of claim 1, wherein the context data associated with the first training data item comprises a feature associated with a user.

5. The method of claim 1, wherein the context data comprises a feature associated with an environment in which the choice data is presented via an application software system.

6. The method of claim 1, wherein the second output is a sampled reward from the distribution.

7. The method of claim 1, further comprising randomly sampling the second output from the distribution.

8. The method of claim 1, wherein the choice data comprises a plurality of target choices, and the method further comprises:
generating, by the first machine learning-based model, a subset of distributions, wherein a first distribution of the subset of distributions is associated with a first target choice of the plurality of target choices.

9. The method of claim 8, wherein generating the first distribution comprises:
generating, by the first machine learning-based model, the first distribution using a continuous probability distribution of the first machine learning-based model, wherein the continuous probability distribution comprises a first parameter and a second parameter.

10. The method of claim 9, wherein the first parameter is a first distribution shape parameter and the second parameter is a second distribution shape parameter.

11. The method of claim 9, wherein the first parameter and the second parameter are learnable parameters, and the method further comprises updating the learnable parameters based on a previously received reward associated with the choice data.

12. The method of claim 8, wherein generating the second output further comprises:
randomly sampling the first distribution and a second distribution of the subset of distributions to obtain a set of sampled rewards; and
generating the second output based on the set of sampled rewards.

13. The method of claim 12, wherein the method further comprises:
randomly sampling the first distribution and the second distribution using Thompson sampling.

14. The method of claim 1, wherein the respective reward data is a ground truth reward.

15. A non-transitory machine-readable storage medium that provides instructions that, when executed by a processor, cause the processor to:
generate a first output using a first machine learning-based model based on context data and choice data of a first training data item;
generate a second output using a second machine learning-based model, wherein the second output comprises an output sampled from a distribution generated based on the first output and reward data of the first training data item;
generate a loss function output using a loss function based on the second output and the reward data of the first training data item; and
update the first machine learning-based model based on the loss function output.

16. The non-transitory machine-readable storage medium of claim 15, wherein the choice data comprises a plurality of target choices, and the method further comprises:
generating, by the first machine learning-based model, a subset of distributions, wherein a first distribution of the subset of distributions is associated with a first target choice of the plurality of target choices.

17. The non-transitory machine-readable medium of claim 16, wherein generating the first distribution comprises:
generating, by the first machine learning-based model, the first distribution using a continuous probability distribution of the first machine learning-based model, wherein the continuous probability distribution comprises a first parameter and a second parameter.

18. A system, comprising:
A processor; and
memory coupled to the processor, wherein the memory comprises instructions that cause the processor to:
generate a first output using a first machine learning-based model based on context data and choice data of a first training data item;
generate a second output using a second machine learning-based model, wherein the second output comprises an output sampled from a distribution generated based on the first output and reward data of the first training data item;
generate a loss function output using a loss function based on the second output and the reward data of the first training data item; and
update the first machine learning-based model based on the loss function output.

19. The system of claim 18, wherein the choice data comprises a plurality of target choices, and the method further comprises:
generating, by the first machine learning-based model, a subset of distributions, wherein a first distribution of the subset of distributions is associated with a first target choice of the plurality of target choices.

20. The system of claim 19, wherein generating the first distribution comprises:
generating, by the first machine learning-based model, the first distribution using a continuous probability distribution of the first machine learning-based model, wherein the continuous probability distribution comprises a first parameter and a second parameter.
